(19) United States
(12) Patent Application Publication
(10) Pub. No.: US 2010/0145861 A1
(43) Pub. Date: Jun. 10, 2010

(54) PAYMENT TRANSACTION PROCESSING FOR MOBILE COMPUTING DEVICES

(75) Inventors: Ringo Law, San Leandro, CA (US); Bharat Welingkar, Los Altos, CA (US); Kelson Tran, San Jose, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/330,389

(22) Filed: Dec. 8, 2008

(51) Int. Cl. G06Q 20/00; G06Q 30/00; G06Q 10/00; H04L 9/32; H04W 4/12

(52) U.S. Cl. 705/76; 705/40; 705/26; 705/30; 455/466

(57) ABSTRACT

A server computer system comprises a memory and a processing circuit. The memory is configured to store supplier identifiers for a plurality of product suppliers. The processing circuit is configured to receive a request to make a payment from a mobile computing device via a wireless communication, to select a supplier identifier from the memory based on the request, to generate a message comprising the supplier identifier, transaction amount, and a user identifier identifying a user of the mobile computing device, and to transmit the transaction message to a server associated with an entity which processes a transaction based on the transaction message.

### BACKGROUND

Mobile computing devices such as mobile phones, smartphones, and personal digital assistants, may be used for a variety of functions. One such function is the processing of payments, for example in a mobile commerce application. In one example, a user runs an Internet browser application on the mobile device to access a web site, select a product for purchase, then type in a credit card number, shipping address, and other data through the browser to pay for the product. The seller of the product then submits the transaction information to a credit card company for payment and ships or downloads the product to the user.

### BRIEF DESCRIPTION OF THE DRAWINGS

FIGS. 1A through 1F illustrate a mobile computing device from various views, according to an exemplary embodiment;

FIG. 2 is a block diagram of the mobile computing device of FIGS. 1A through 1F, according to an exemplary embodiment;

FIG. 3 is a block diagram of a system and method for payment transaction processing for mobile computing devices, according to an exemplary embodiment;

FIG. 4 is a block diagram of a system and method for payment transaction processing for mobile computing devices, according to an alternative embodiment;

FIG. 5 is a block diagram of a system and method for registering an application developer, according to an exemplary embodiment;

FIG. 6 is a user interface and flow diagram illustrating steps in validating a user account, according to an exemplary embodiment;

FIG. 7 is a flow diagram illustrating a payment history viewing process, according to an exemplary embodiment; and

FIG. 8 is a user interface and flow diagram illustrating a payment history viewing process, according to an exemplary embodiment.

### DETAILED DESCRIPTION OF THE EXEMPLARY EMBODIMENTS

Described herein are various exemplary embodiments of systems and methods for payment transaction processing for mobile computing devices. Some embodiments may allow developers of software applications operable on the mobile device to monetize their applications without having to implement their own billing mechanism by having their applications use a common payment application. Some embodiments may provide a convenient, consistent, integrated buying experience for users of the mobile device when paying for products (goods, services, applications, etc.) or making other payment transactions. Some embodiments may further provide allow a “one-click” buying experience. Some embodiments may realize efficiencies of using an existing third party payment provider to clear financial transactions made with the device. Some embodiments may provide a same or similar user interface for processing payments for a variety of products and services offered by different sellers. Some embodiments may provide a payment initiative on-device for purchases made over the Internet. Some embodiments may allow authentication on-device instead of through a proxy to reduce the risk of a security attack on user credentials.

The teachings herein extend to those embodiments that fall within the scope of the appended claims, regardless of whether they accomplish one or more of the above-mentioned exemplary advantages.

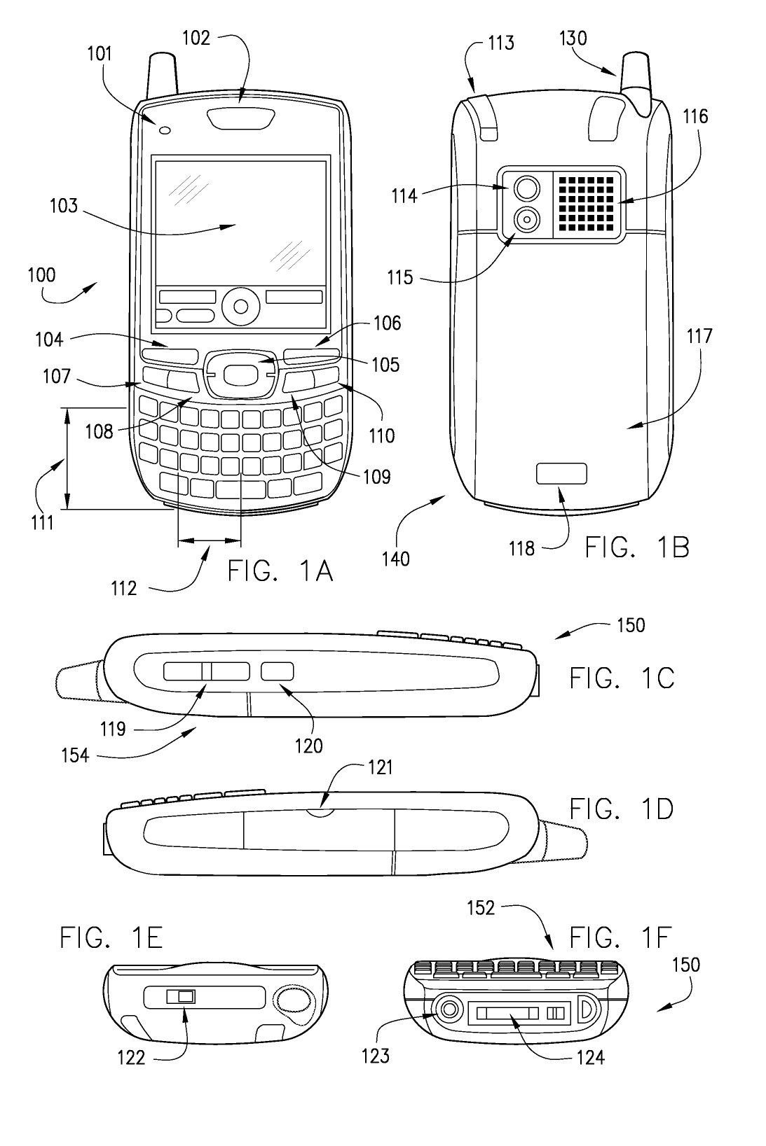

Referring to FIGS. 1A through 1F, a mobile computing device 100 is shown from various angles, according to an exemplary embodiment. FIG. 1A is a front view of device 100; FIG. 1B is a rear view of device 100; FIGS. 1C and 1D are side views of device 100; and FIGS. 1E and 1F are top and bottom views of device 100. The device may be any type of communications or computing device (e.g., a cellular phone, other mobile device, digital media player (e.g., audio or audio/video), personal digital assistant, etc.).

Device 100 may be a smart phone, which is a combination mobile telephone and handheld computer having personal digital assistant (“PDA”) functionality. The teachings herein can be applied to other mobile computing devices (e.g., a laptop computer) or other electronic devices (e.g., a desktop personal computer, etc.). PDA functionality can comprise one or more of personal information management, database functions, word processing, spreadsheets, voice memo recording, location-based services, device backup and lock, media playing, Internet browsing, etc. and is configured to synchronize personal information or user data (e.g., contacts, e-mail, calendar, notes, to-do list, web browser favorites, etc.) from one or more applications with a computer (e.g., desktop, laptop, server, etc.). Device 100 is further configured to receive and operate additional applications provided to device 100 after manufacture, e.g., via wired or wireless download, Secure Digital card, etc.

Device 100 may be a handheld computer (e.g., a computer small enough to be carried in a typical front pocket found in a pair of pants or other similar pocket), comprising such devices as typical mobile telephones and PDAs, but the term “handheld” and the phrase “configured to be held in a hand during use” excluding typical laptop computers and tablet personal computers (“PCs”) for purposes of this disclosure. In alternative embodiments, the teachings herein may extend to laptop computers, tablet PCs, desktop PCS, and other electronic devices. The various input devices and other parts of device 100 as described below may be positioned anywhere on device 100 (e.g., the front side of FIG. 1A, the rear side of FIG. 1B, the sides of FIGS. 1C and ID, etc.).

Device 100 includes various user input devices. For example, the user input devices may include a send button 104 usable to select options appearing on display 103 and/or send messages, a 5-way navigator 105 usable to navigate through options appearing on display 103, a power/end button 106 usable to select options appearing on display 103 and to turn on display 103, a phone button 107 usable to access a phone application screen, a calendar button 108 usable to access a calendar application screen, a messaging button 109 usable to access a messaging application screen (e.g., e-mail, text, Multimedia Messaging Service (MMS), etc.), an applications button 110 usable to access a screen showing available applications, a thumb keyboard 111 (which includes a phone dial pad 112 usable to dial during a phone application), a volume button 119 usable to adjust the volume of audio output of device 100, a customizable button 120 which a user may customize to perform various functions, a ringer switch 122 usable to switch the device from one mode to another mode (such as switching from a normal ringer mode to a meeting ringer mode), and a touch screen display 103 usable to select control options displayed on display 103. Device 100 may further comprise a button or switch usable to make purchase with device, such as at a point of sale terminal or via wireless communication with a web site. The purchase button may be usable to begin a payment application, such as a payment approval process operable on device 100 according to any of the embodiments described herein or other embodiments.

Device 100 also includes various audio circuits. The audio circuits may include phone speaker 102 usable to listen to information in a normal phone mode, external speaker 116 louder than the phone speaker (e.g. for listening to music, for a speakerphone mode, etc.), headset jack 123 to which a user can attach an external headset which may include a speaker and/or a microphone, and a microphone that can be used to pick up audio information such as the user's end of a conversation during a phone call.

Device 100 may also include a status indicator 101 that can be used to indicate the status of device 100 (such as messages pending, charging, low battery, transaction complete, etc.), a stylus slot 113 for receiving a stylus usable to input data on touch screen display 103, a digital camera 115 usable to capture images, a mirror 114 positioned proximate camera 115 such that a user may view themselves in mirror 114 when taking a picture of themselves using camera 115, a removable battery 118, and a connector 124 which can be used to connect device 100 to either (or both) an external power supply such as a wall outlet or battery charger or an external device such as a personal computer, a global positioning system (“GPS”) unit, a display unit, or some other external device.

Device 100 may also include an expansion slot 121 that may be used to receive a memory card and/or a device which communicates data through slot 121, and a Subscriber Identity Module (SIM) card slot 117, located behind battery 118, configured to receive a SIM card or other card that allows the user to access a cellular network.

In various embodiments device 100 may include a housing 140. Housing 140 may be configured to retain or secure a screen in a fixed relationship above a plurality of user input devices in a substantially parallel or same plane. A fixed relationship may exclude a hinged or movable relationship between the screen and plurality of keys in the fixed embodiment, though hinged or movable relationships may be used in other embodiments.

Housing 140 could be any size, shape, and dimension. In some embodiments, housing 140 has a width (shorter dimension) of no more than about 200 mm or no more than about 100 mm, or a width of at least about 30 mm or at least about 50 mm. In some embodiments, housing 140 has a length (longer dimension) of no more than about 200 mm or no more than about 150 mm, or a length of at least about 70 mm or at least about 100 mm. In some embodiments, housing 140 has a thickness (smallest dimension) of no more than about 150 mm or no more than about 50 mm, or a thickness of at least about 10 mm or at least about 15 mm. In some embodiments, housing 140 has a volume of up to about 2500 cubic centimeters and/or up to about 1500 cubic centimeters.

Device 100 may include an antenna 130 system for transmitting and/or receiving radio frequency signals. Each transceiver of device 100 may include individual antennas or may include a common antenna 130. The antenna system may include or be implemented as one or more internal antennas and/or external antennas.

While described with regards to a handheld device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (“CDMA”) cellular radiotelephone communication systems, Global System for Mobile Communications (“GSM”) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (“GPRS”) systems (“GSM/GPRS”), CDMA/1×RTT (1 times Radio Transmission Technology) systems, Enhanced Data Rates for Global Evolution (“EDGE”) systems, Evolution Data Only or Evolution Data Optimized (“EV-DO”) systems, etc.

Device 100 may be configured to provide voice and/or data communications functionality through wireless access points (“WAPs”) in accordance with different types of wireless network systems. A wireless access point may comprise any one or more components of a wireless site used by device 100 to create a wireless network system that connects to a wired infrastructure, such as a wireless transceiver, cell tower, base station, router, cables, servers, or other components depending on the system architecture. Examples of wireless network systems may further include a wireless local area network (“WLAN”) system, wireless metropolitan area network (“WMAN”) system, wireless wide area network (“WWAN”) system (e.g., a cellular network), and so forth. Examples of suitable wireless network systems offering data communication services may include the Institute of Electrical and Electronics Engineers (“IEEE”) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (“PAN”) system, such as a Bluetooth® system operating in accordance with the Bluetooth Special Interest Group (“SIG”) series of protocols.

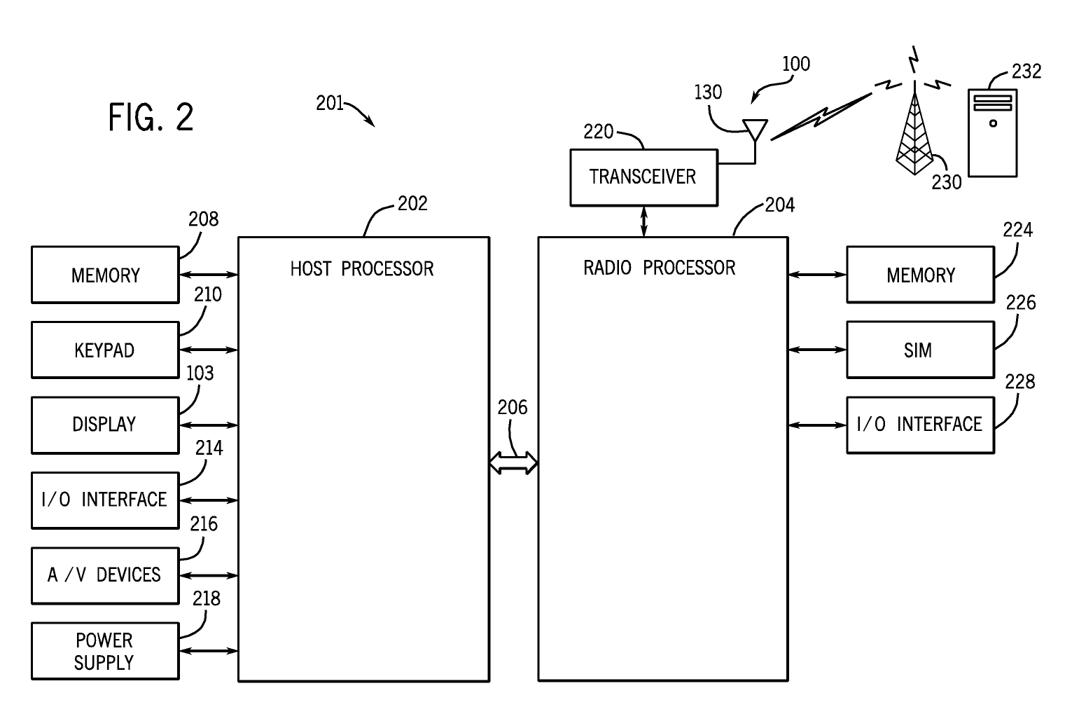

As shown in the embodiment of FIG. 2, device 100 comprises a processing circuit 201, which may comprise a dual processor architecture, including a host processor 202 and a radio processor 204 (e.g., a base band processor or modem). Host processor 202 and radio processor 204 may be configured to communicate with each other using an interface 206 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth.

Host processor 202 may be configured to execute various computer programs (e.g., software, firmware, or other code) such as application programs and system programs to provide computing and processing operations for device 100. Radio processor 204 may be responsible for performing various voice and data communications operations for device 100 such as transmitting and receiving voice and data information over one or more wireless communications channels. Although embodiments of the dual processor architecture may be described as comprising host processor 202 and radio processor 204 for purposes of illustration, the dual processor architecture of device 100 may comprise one processor, more than two processors, may be implemented as a dual- or multi-core chip with both host processor 202 and radio processor 204 on a single chip, etc. Alternatively, a single processor or multiple processors may perform the functions of host processor 202 and radio processor 204, such as a single, unified processor that handles host and radio functions, or other multiprocessor topologies which do not rely on the concept of a host. Alternatively, processing circuit 201 may comprise any digital and/or analog circuit elements, comprising discrete and/or solid state components, suitable for use with the embodiments disclosed herein.

In various embodiments, host processor 202 may be implemented as a host central processing unit (“CPU”) using any suitable processor or logic device, such as a general purpose processor. Host processor 202 may comprise, or be implemented as, a chip multiprocessor (“CMP”), dedicated processor, embedded processor, media processor, input/output (“I/O”) processor, co-processor, field programmable gate array (“FPGA”), programmable logic device (“PLD”), or other processing device in alternative embodiments.

Host processor 202 may be configured to provide processing or computing resources to device 100. For example, host processor 202 may be responsible for executing various computer programs such as application programs and system programs to provide computing and processing operations for device 100. Examples of application programs may include, for example, a telephone application, voicemail application, e-email application, instant message (“IM”) application, short message service (“SMS”) application, multimedia message service (“MMS”) application, web browser application, personal information manager (“PIM”) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (“GUI”) to communicate information between device 100 and a user. The computer programs may be stored as firmware on a memory associated with processor 202, may be loaded by a manufacturer during a process of manufacturing device 100, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system (“OS”), a kernel, device drivers, programming tools, utility programs, software libraries, an application programming interface (“API”), a GUI, and so forth. Device 100 may utilize any suitable OS in accordance with the described embodiments such as a Palm OS®, Palm OS® Cobalt, Microsoft Windows®OS, Microsoft Windows® CE, Microsoft Pocket PC, Microsoft Mobile, Symbian OS™, Embedix OS, any Linux distribution, Binary Run-time Environment for Wireless (“BREW”) OS, JavaOS, a Wireless Application Protocol (“WAP”) OS, and so forth.

Device 100 may comprise a memory 208 coupled to host processor 202. In various embodiments, memory 208 may be configured to store one or more computer programs to be executed by host processor 202. Memory 208 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (“RAM”), dynamic RAM (“DRAM”), Double-Data-Rate DRAM (“DDRAM”), synchronous DRAM (“SDRAM)”, static RAM (“SRAM”), read-only memory (“ROM”), programmable ROM (“PROM”), erasable programmable ROM (“EPROM”), electrically erasable programmable ROM (“EEPROM”), flash memory (e.g., NOR or NAND flash memory), or any other type of media suitable for storing information.

Although memory 208 is shown as being separate from host processor 202 for purposes of illustration, in various embodiments some portion or the entire memory 208 may be included on the same integrated circuit as host processor 202. Alternatively, some portion or the entire memory 208 may be disposed on an integrated circuit or other medium (e.g., hard disk drive) external to the integrated circuit of host processor 202. In various embodiments, device 100 may comprise a memory port or expansion slot 121 (shown in FIG. 1) to support a multimedia and/or memory card, for example. Processing circuit 201 may use memory port or expansion slot 121 to read and/or write to a removable memory card having memory, for example, to determine whether a memory card is present in port or slot 121, to determine an amount of available memory on the memory card, to store subscribed content or other data or files on the memory card, etc.

Device 100 may comprise a user input device 210 coupled to the host processor 202. User input device 210 may comprise, for example, a alphanumeric, numeric or QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth. Examples of such objects are shown in FIG. 1 as 5-way navigator 105, power/end button 106, phone button 107, calendar button 108, messaging button 109, applications button 110, thumb keyboard 111, volume button 119, customizable button 120, and ringer switch 122.

The host processor 202 may be coupled to display 103. Display 103 may comprise any suitable visual interface for displaying content to a user of device 100. For example, display 103 may be implemented by a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program. Display 18 may be configured to receive a finger swipe or other directional input, which may be interpreted by a processing circuit to control certain functions distinct from a single touch input.

Device 100 may comprise an I/O interface 214 coupled to the host processor 202. I/O interface 214 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a PC, or a remote computer system, such as a computer server. In various implementations, device 100 may be configured to transfer and/or synchronize information with the local computer system, such as personal information management data stored in one or more databases in memory 208.

Host processor 202 may be coupled to various audio/video (“A/V”) devices 216 that support A/V capability of device 100. Examples of A/V devices 216 may include, for example, a microphone, one or more speakers, an audio port to connect an audio headset, an audio coder/decoder (codec), an audio player, a digital camera, a video camera, a video codec, a video player, and so forth.

Host processor 202 may be coupled to a power supply 218 configured to supply and manage power to the elements of device 100. In various exemplary embodiments, power supply 218 may be implemented by a rechargeable battery, such as a removable and rechargeable lithium ion battery to provide direct current (“DC”) power, and/or an alternating current (“AC”) adapter to draw power from a standard AC main power supply.

As mentioned above, radio processor 204 may perform voice and/or data communication operations for device 100. For example, radio processor 204 may be configured to communicate voice information and/or data information over one or more assigned frequency bands of a wireless communication channel. Radio processor 204 may be implemented as a communications processor using any suitable processor or logic device, such as a modem processor or baseband processor. Radio processor 204 may comprise, or be implemented as, a digital signal processor (“DSP”), a media access control (“MAC”) processor, or any other type of communications processor in accordance with the described embodiments. Radio processor 204 may be any of a plurality of modems manufactured by Qualcomm, Inc. or other manufacturers.

Device 100 may comprise a transceiver 220 coupled to radio processor 204. Transceiver 220 may comprise one or more transceivers configured to communicate using different types of protocols, communication ranges, operating power requirements, RF sub-bands, information types (e.g., voice or data), use scenarios, applications, and so forth. For example, transceiver 220 may comprise a Wi-Fi transceiver and a cellular or WAN transceiver configured to operate simultaneously.

Transceiver 220 may be implemented using one or more chips as desired for a given implementation. Although transceiver 220 is shown as being separate from and external to radio processor 204 for purposes of illustration, in various embodiments some portion or the entire transceiver 220 may be included on the same integrated circuit as radio processor 204.

Device 100 may comprise an antenna or antenna system 130 for transmitting and/or receiving electrical signals. As shown, antenna system 130 may be coupled to radio processor 204 through transceiver 220. Radio tower 230 and server 232 are shown as examples of potential objects configured to receive a signal from antenna system 130.

Device 100 may comprise a memory 224 coupled to radio processor 204. Memory 224 may be implemented using any type of memory described with reference to memory 208. Although memory 224 is shown as being separate from and external to radio processor 204 for purposes of illustration, in various embodiments some portion or the entire memory 224 may be included on the same integrated circuit as radio processor 204. Further, host processor 202 and radio processor 204 may share a single memory.

Device 100 may comprise a SIM 226 coupled to radio processor 204. SIM 226 may comprise, for example, a removable or non-removable smart card configured to encrypt voice and data transmissions and to store user-specific data for allowing a voice or data communications network to identify and authenticate the user. SIM 126 also may store data such as personal settings specific to the user.

Device 100 may comprise an I/O interface 228 coupled to the radio processor 204. I/O interface 228 may comprise one or more I/O devices to enable wired (e.g., serial, cable, etc.) and/or wireless (e.g., WiFi, short range, etc.) communication between device 100 and one or more external computer systems.

In various embodiments, device 100 may comprise location or position determination capabilities. Device 100 may employ one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

In various embodiments, device 100 may comprise dedicated hardware circuits or structures, or a combination of dedicated hardware and associated software, to support position determination. For example, transceiver 220 and antenna system 130 may comprise GPS receiver or transceiver hardware and one or more associated antennas coupled to radio processor 204 to support position determination.

Host processor 202 may comprise and/or implement at least one location-based service (“LBS”) application. In general, the LBS application may comprise any type of client application executed by host processor 202, such as a GPS application configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (“POI”) such as restaurants, hotels, landmarks, and entertainment venues, and other types of LBS services in accordance with the described embodiments.

Radio processor 204 may be configured to generate a position fix by configuring a position engine and requesting a position fix. For example, a position engine interface on radio processor 204 may set configuration parameters that control the position determination process. Examples of configuration parameters may include, without limitation, location determination mode (e.g., standalone, Mobile Station-assisted, Mobile Station-based), actual or estimated number of position fixes (e.g., single position fix, series of position fixes, request position assist data without a position fix), time interval between position fixes, Quality of Service (“QoS”) values, optimization parameters (e.g., optimized for speed, accuracy, or payload), Position Determination Entity address (e.g., IP address and port number of LPS or MPC), etc. In one embodiment, the position engine may be implemented as a QUALCOMM® gpsOne® engine.

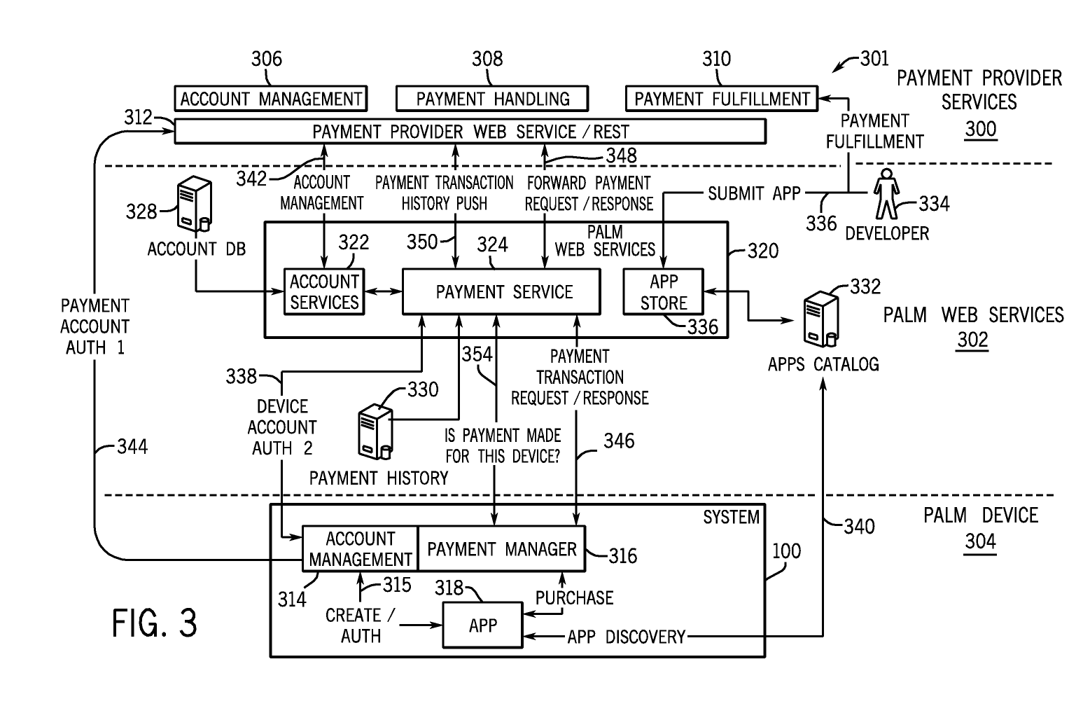

Referring to FIG. 3, a block diagram of a system and method for payment transaction processing will be described. In this embodiment, three layers are illustrated, a payment provider services layer 300, an intermediate services layer 302, and a mobile computing device layer 304. The elements of intermediate services layer 302 comprise computing elements distinct from computing elements of payment provider services layer 300. Layers 300 and 302 may communicate with each other over a wide area network, such as the Internet. Intermediate services layer 302 may be operated by an entity such as a manufacturer of the device used in device layer 304, such as Palm, Inc., of Sunnyvale, Calif. Payment provider services layer 300 may be operated by a payment provider, such as, PayPal, an eBay company of San Jose, Calif., Amazon Flexible Payment Service (FPS), provided by Amazon.com of Seattle, Wash., or other payment provider or payment processing entities, such as credit agencies, banks, commercial lenders, etc. In alternative embodiments, layers 300 and 302 may be provided by a single entity.

Payment provider services layer 300 comprises a server computer system 301 comprising one or more server computers and associated programming thereof to provide payment services to consumers and businesses. The functional components of such a system 301 may comprise an account management unit 306, a payment handling unit 308, a payment fulfillment unit 310, and a payment provider web service 312. Account management unit 306 may be configured to communicate via web service 312 with users via the Internet, either via wired connections, such as to provide an interactive website such as PayPal.com, or via wireless connections to mobile devices, such as to provide a service such as PayPal Mobile accessible by the devices via an Internet browser or a native or local application operable on the devices. Account management unit 306 is configured to receive user data, such as user credentials, such as a username and password, address, telephone, financial account or funding source information, account preferences, and other user data. Financial account or funding source information may comprise an account holding funds operated by the payment provider (e.g., a Paypal account), an electronic check, an instance automated clearinghouse, such as an ACH debit, a credit card number, a buyer credit account managed by the payment provider, a backup funding source, etc. Funding source types may comprise a bank account, a credit or debit card, a payment provider account balance, a payment provider buy credit account, etc. The user's payment provider account may further list funding sources by subtypes, such as a credit card type, a debit card type, etc. Account management unit 306 is configured to create accounts for users of payment provider services layer 300 and to store user account data in a memory or account database.

Payment handling unit 308 is configured to receive user requests for transactions to be made between the user and other parties. Payment fulfillment unit 310 is configured to fulfill or carry out the transactions between different users of layer 300 or between a user of layer 300 and another entity, such as a credit card institution, bank, etc. Payment provider web service 312 is configured to provide communications between the various elements of layer 300 and a user such as device 100, users using a wired connection, and other users. Web service 312 may operate according to a representational state transfer (REST) software architecture, using a hypertext transfer protocol (HTTP) specification, and/or other network architectures or protocols. Web service 312 may provide a set of application programming interfaces (APIs), which may be available via a Simple Object Access Protocol (SOAP), or other protocol for invoking code using an eXtensible Markup Language (XML) over HTTP. The APIs may allow such functions as logging payment sender into the sender's payment provider account, getting the payment sender's account balance, initiating a payment request, retrieving available funding sources and shipping addresses from the sender's account, choosing a payment source and shipping address for a given payment request, completing the payment request, obtaining payment history, etc.

Device layer 304 comprises a mobile computing device 100, in this example having an account management unit 314, a payment manager 316, and a downloaded application 318. Each of units 314, 316, and 318 may comprise code stored in any type of memory, such as non-volatile memory (e.g., read-only memory, flash memory, hard disk, optical disk, etc.) and may be stored as different objects or routines to provide the different functions or may be stored in a manner in which the different functions are provided by a single object or multiple objects. Thus, recitation of a “unit” or representation of a functional component as a block in any of the figures described herein is not intended to limit any implementation to a single hardware or software unit.

Account management unit 314 is configured to interface with a user via a display, keyboard, microphone, speaker, etc. to receive account data, such as user credentials, such as a username, password, biometric input, and other user data to be used to create an account to be stored on any of device 100, payment provider server computer system 301, and an intermediate server computer system 302. In one embodiment, once system 301 verifies or authenticates the user's payment account from payment provider 300, the sender/session token that is returned from the payment provider may be stored by account management unit 314 in a user account file. When the token is needed for payment processing, it may be retrieved from account management. In another embodiment, account management unit 314 is configured to maintain an account for other services offered by layer 302, such as a backup/restore service for personal data, a software updates service, or other services. This services account may be combined with, share common elements with, or use the same format as a payment account.

Payment manager 316 is configured to receive a request from the user to process payment and to communicate with elements of layers 302 and/or 300 to handle or fulfill the payment. Downloaded application 318 illustrates one implementation of this system and method for the purchase of applications downloadable and operable on device 304, though the systems and methods described herein may be implemented for any transaction for any products, services, etc., whether on-line or in person at a physical point of sale terminal.

Intermediate services layer 302 comprises a server computer system 320 configured to serve device 100. System 320 may comprise one or more physical computing systems or computers having various memory, processing circuits, network communication circuitry, etc. Layer 302 may provide an enabling role in payment transactions and may provide complimentary functions to the payment provider layer 300. Server computer system 320 comprises an account services unit 322, a payment services unit 324 and an applications store 326. Server computer system 320 further may comprise an account database 328, a payment history database 330, and an applications catalog database 332. A developer entity 334 is shown interacting with layers 300 and 302. Developer entity 334 may be an entity that creates applications, services, or other products operable on device 304 for purchase, download, and use on device 100. Developer entity 334 may be a separate entity from the entities operating layers 300 and 302 and manufacturing device 304, or any of these entities may be the same, similar or related entities. Developer entity 334 may operate a computer to access layers 300 and 302 to communicate therewith and to provide the functions described herein. Applications catalog database 332 may store applications for download to devices and a list of the applications along with pertinent information, such as the developer of the application, cost, payment models, payment providers allowed, etc. Database 332 may store applications created by third party developers or by the entity operating layer 302 and/or manufacturing device 100. As part of the application upload process, a secure application signing system may be used, such as described in U.S. Provisional Patent Application No. 61/062,758, filed Jan. 29, 2008, to Welingkar et al., which is herein incorporated by reference in its entity.

In this embodiment, intermediate layer 302 links third party application developers 334 to device 304 to sell applications for device 100 and to process payments using payment provider services layer 300. Generally, developers 334 submit one or more applications to applications store 326. When a user of device 100 wishes to purchase and download one of the applications, server computer system 320 provides payment processing functions for the purchase of the application. During the payment processing, device 100 is authenticated with payment provider layer 300 to make sure the user has a valid account for payment. Intermediate layer 302 may be operable with one or a plurality of payment providers and is configurable to allow adding or deleting of different payment providers.

The functions of layers 300, 302 and 304 will now be described in exemplary embodiments.

### Developer Registration

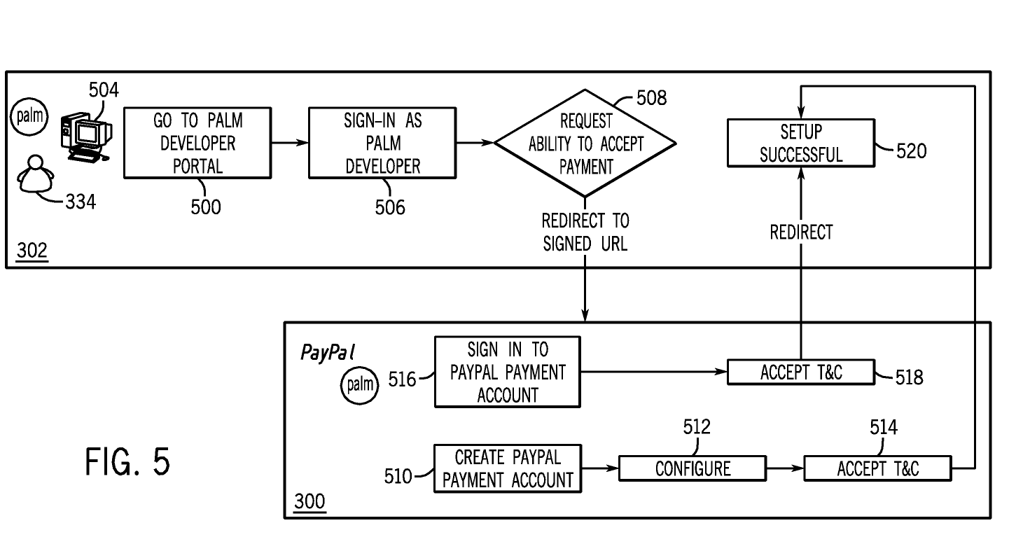

Referring to FIG. 5, a block diagram of a system and method for registering an application developer will be described. A developer or other entity uploads applications available for purchase to that a user of device 100 can shop for applications via applications catalog 332 and applications store 326 (FIG. 3). At step 500, developer 334 accesses a developer portal for system 320 using developer computer 504 and an Internet connection. At step 506, entity 334 signs in or logs in as a developer using a web portal. If this is a first time sign in, the developer creates a developer account, comprising developer name, credentials, financial account information (such as an account to which the developer wishes to be paid for the applications uploaded and purchased by the user), addresses, credit ratings, and any other information about the developer. System 320 may be configured to receive an indication of which payment providers the developer wishes to offer to users for payment. These options for payment provider may then be provided to a user of device 100 at the time of purchase. Intermediate services system 320 is configured to store the account data in account database 328 (FIG. 3). At step 508, system 320 receives a request from the developer to provide the ability to accept payment for one or more of the applications to be uploaded.

At step 510, the developer creates a payment account with payment provider services at payment provider system 301. System 301 may provide web access via its own web portal for the user to enter account information, and to store the user's account in an account database associated with system 301. Thus, the developer registers a business account with both a payment provider at system 301 and a separate business account with intermediate services system 320. Alternatively, developer 334 may create an account with the payment provider through intermediate services system 320 which works with system 301 to create an account.

In step 512, system 301 is configured to set up the user account and to store the account data in the database. At step 514, system 301 is configured to provide terms and conditions of use of system 301 and/or layer 320, either alone or together, which the provider must then accept before proceeding further with registration.

Returning to step 508, system 320 is configured to request the developer's account identification (ID) from the developer's payment provider account established in steps 510-514. System 320 is configured to store this as a supplier identifier (the developer being the supplier of the product) in account database 328 (FIG. 3). This data can later be used by system 320 to instruct payment provider 300 to forward money to the account during payment fulfillment. System 320 redirects the developer next to a signed uniform resource locator (URL) to provide the developer to a web portal at step 516. At step 516, the developer signs in to their account and is presented with a set of terms and conditions which must be accepted at step 518. The terms and conditions may further comprise transaction fees, such as a percentage fee, maximum fee, minimum fee, etc., to be charged by the entities associated with layers 300 and/or 302 in exchange for selling or offering their products for sale. At step 518, if the developer accepts the terms and conditions, system 301 redirects the developer back to system 320 and, at a step 520, assuming other terms and conditions have been accepted to create a valid account with layer 300, an indication is provided to the developer that the set-up process has been successful. The account identifier with layer 300 may comprise an e-mail address, since some payment providers are configured to send payment notifications to an e-mail address. At a later time, when a user of device 100 makes a purchase or payment for an application uploaded by developer 334, money will be debited from the buyer's account and a portion of the money will go to one or more of accounts associated with the entities operating layers 300 and/or 302, or other agencies (e.g., advertising companies, financial institutions, etc.).

Returning to FIG. 3, a developer can now submit applications 336 for purchase by a user of device 100.

### User Account Generation

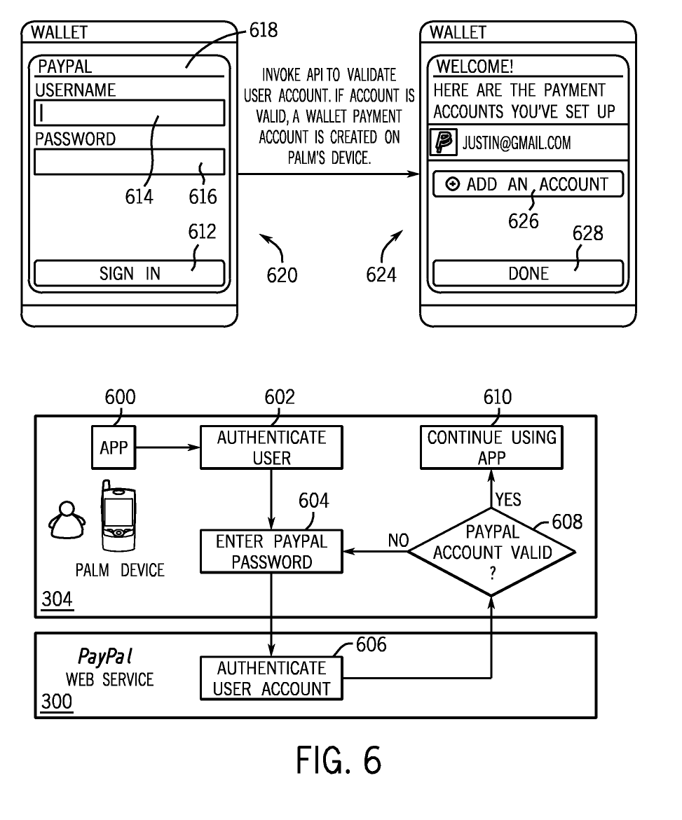

Referring now to FIG. 6, a user interface and flow diagram illustrating steps in generating or validating a user account will be described. A user creates an account with one or more payment providers 300, which may be done using mobile device 100 or via a desktop or laptop computer with a wired connection to the Internet. The user supplies certain user information, such as an e-mail address, username, password, shipping address, billing address, credit card information, preferences, etc. Then, the user may use device 100 to generate or verify a payment account on device 100 and/or system 320 using one or more user credentials for the account for the payment provider's system.

According to one embodiment, when device 100 is first activated (e.g., a “first use” state), the device may be configured to prompt the user to register the device with the manufacturer and/or with an entity operating intermediate service layer 302. During this process, device 100 may be configured to collect information from the user, such as, language selection, home address, etc. Device 100 is configured to communicate with layer 302 via device account authorization step 338 (FIG. 3) to create one or more accounts with system 320, such as a services account, a payment account, a combined services and payment account, etc. Once an account is created and a device is registered, the device may access one or more services provided by system 320, such as an applications discovery service via a step 340 (FIG. 3) configured to allow the device to discover or view applications available for download from applications store 326. The payment manager application 316 may be operable from within an application native to the operating system of device 100 or downloaded from an application discovery service or from the Internet to device 100 (e.g., by the application launching the payment manager application, directing the user to the payment manager application with a user input device, opening the payment manager application in a sub-window smaller than the total screen while the application user interface persists in the background, etc.). A Java Script Object Notation (JSON) interface for applications operating on device 100 may be configured to invoke portions of the payment manager application 316. The interface may further handle sender token management (such as persisting tokens that define per-use validity), transaction unit identification (e.g. an identifier assigned to each transaction so that the transaction may be referenced at a later time), and/or other functions. The payment manager application 316 may generate/authenticate/or validate a user account with a payment provider, make a payment, etc. Device 100 may further be configured to operate an application catalog application which may comprise a user interface (e.g., a “storefront” user interface) configured to provide user-selectable links to view a list of downloadable applications, shop on the Internet at other web sites, etc.

Returning to FIG. 6, as part of the first use application or during other interaction with the device (e.g., when an application or other product is selected for purchase), an application 600 is operated on device 100 which is configured to provide a user interface to the user to allow the user to authenticate a payment account with payment provider service 300 and/or generate a payment account on device 100 and/or system 320. At step 602, device 100 is configured to authenticate the user, for example, by prompting the user for a password. Device 100 may also or alternatively authenticate the user by receiving one or more biometric inputs to match previously-stored biometric inputs on device 100, or other data used to authenticate the user (e.g., last four of social security number, mother's maiden name, etc.). Alternatively, at step 602, the device user's username and password previously created for their account with payment provider 300 may be used to authenticate the user in this process. At step 604, device 100 is configured to receive the payment provider's password. The user credentials are sent to layer 300 through layer 302 (as shown at steps 338 and 342 in FIG. 3). If the user has a valid payment provider account (step 608), a user account for this payment provider is created on device 100 and also stored by system 320 on account database 328 (FIG. 3). According to one embodiment, a user password is removed from memory on device 100 after the completion of authentication (at step 610 in this embodiment) to prevent the password from being retrieved without authorization at some later time. In one embodiment, only the username is persisted on device 100, though in alternative embodiments, other non-password information may be persisted on device 100 as part of the user's payment account generated on device 100.

If, during steps 604 and 606, it is determined by either layers 302 or 300 that the user does not have a payment provider account, the user may be prompted to create a payment provider account through the application operating on device 100. This application may be part of a payment manager application 316. Device 100 may comprise a near field communications device and may be used for payments, which may be processed in whole or in part using the systems and methods described herein. U.S. patent application Ser. No. 12/328,654, filed Dec. 4, 2008, entitled “Method of and System for Secure On-Line Purchases” to Karl A. Townsend, is hereby incorporated by reference in its entirety.

According to one advantageous embodiment, the application configured to create a user account for payment transactions on device 100, such as according to the embodiment of FIG. 6, may be an application that is locally operated on the processing circuit of device 100. The application may be part of a payment application comprising user interface elements, such as a “sign in” button 612, a username entry field 614, a password entry field 616, a title banner 618, or other user interface elements, such as in software or firmware form. The payment application may be stored in non-volatile memory (e.g., read only memory, flash, etc.). The processing circuit may be configured to operate the payment application out of the non-volatile memory, to retrieve the user interface elements, and to provide a user interface 620 to receive one or more user credentials from the user. In this example, the payment application is not an Internet browser application of the type currently in use, though in other alternative embodiments, it may be an Internet browser application. The payment application may be local or native to device 100, i.e., stored on the device and operated therefrom, such as from a portion of the operating system, an application pre-loaded during manufacture on device 100, or an application downloaded to device 100 before being operated, etc. According to one advantage, by operating such an application that is local to device 100, a consistent and integrated buying experience can be provided to end users when setting up or generating an account as in FIG. 6, as well as when payment transactions are to be made as will be described herein. For purchases of different application from application store 326 or from different web sites, an at least partially consistent or uniform user interface may be provided to the user to receive and process payment transactions. The user interface may be used for verification of the account, acknowledgement of the transaction, potential onboarding (e.g., getting a user acquainted with the system, such as through a “virtual tour,” help menu, etc.), etc.

Referring again to FIG. 6, user interface 620 is configured to receive a username and password. User interface 620 may be presented automatically when a process payment transaction API is invoked by the developer's software application and if the user has not verified the account with the chosen payment provider of a particular transaction. System 320 then invokes the payment provider's authentication application programming interface (API) to validate the user account. If the account is valid, an account is created by account manager 314 on device 304 once instructed by system 320. Validation may comprise verifying with payment provider 300 that the user's given account credentials with the payment provider work and therefore that future transactions can take place. A user interface 624 is then provided indicating that a payment provider account has been saved on device 100 and listing any other accounts for this payment provider or for other payment providers which have been created on device 100. An add account input device 626 is provided. In response to pressing the add account input device, the device 100 returns to user interface 620 or a similar user interface to receive additional data for other accounts to be added to the device. A done button 628 is provided to allow a user to indicate when they are done creating/validating accounts and would like to return to other processing.

### Payment Processing

Referring now to FIG. 3, steps in a payment processing will be described according to various embodiments. Device 100 is configured to provide a screen to the user to illustrate user selection of a product (e.g., an application 318 selected from an application discovery process 340, a product from an on-line retailer such as a physical good or service or a digital good or service (e.g., an .MP3 audio file), etc.) or a payment to be made to another account (e.g., a personal payment to another person's account with the payment provider). The screen can be provided by a third party application operated locally or as a native application on the device (as described above) based on data retrieved from applications store 326 (FIG. 3) or from another web-based source (e.g., a web retailer such as Amazon.com accessed via an Internet browser). While viewing the selected product, the user may request to enter a check out or payment mode or otherwise request to purchase the selected item. A soft key, hard key, touch screen input device, or other input device may be used to invoke a payment application on device 100.

In this embodiment, browser-based purchases are processed through layer 302, wherein purchase requests may be intercepted by payment manager application 316 and transacted through layer 302. A native browser plug-in may be used for purchases. For a personal payment process, person-to-person payment transactions may be enabled by integration with social networking applications or data sources (e.g., a Contacts application, Facebook, LinkedIn web pages, etc.), and may include solutions for social affiliations of end-users, such as community donations, charitable contributions, etc.

In payment or check out mode, device 100 is configured to display a screen configured to prompt the user to enter a selection of a payment method, which may comprise a selection of a payment provider 300. Device 100 may further be configured to prompt the user to enter one or more user credentials (step 315) to be used to request authentication from the account management unit 306 of the selected payment provider (e.g., at layer 300). One or more user credentials may be retrieved from memory on device 100, such as a user's e-mail address associated with a payment provider account. The credentials may comprise an e-mail address associated with a payment provider account and a password, or a phone number for device 100 and a personal identification number or PIN, or other credentials or sets of credentials. The request for authentication may be generated by payment management unit 316 and sent to the account management unit 306 of layer 300. As shown at payment account authorization step 344, device 100 is configured to receive at least one credential from the user, such as a username, password, etc. and to transmit the credential or credentials via wireless communication to a payment provider server 301 (configured to operate an account management unit 306 and/or other functional units). In this exemplary embodiment, the credential or credentials and request for authentication are sent directly to system 301 (i.e., not via system 320), though in alternative embodiments system 320 may forward the request. A secure communication connection, such as HTTPS, may be used; the user credentials may be encrypted.

The request may use an application programming interface (API) operable on system 301 to receive the request for authentication and to transmit in reply an indication of success or failure of the authentication attempt. The response may further comprise a security file, such as a token, certificate, or other data indicative of the user being authenticated to device 100, which can be used to start a payment request with server 301. Device 100 may then be configured to indicate to the user success or failure of the authentication using a user interface on device 100.

At a user interface, a user command to make a purchase may be received by device 100. In response to this request, device 100 may be configured to send a transaction message or payment request which may comprise one or more of the security file, a transaction amount, a product or service identifier, an identifier of the supplier of the product to be purchased, a user identifier (e.g., a username, e-mail address, etc.), a transaction unit identifier, or other data needed to process a transaction, as shown at step 346. The transaction message may comprise a payment sender identifier (i.e. an identifier of the party who pays for the goods or services, which may be the owner of device 100), a payment recipient identifier (i.e. an identifier of the party to receive the payment, which may be the party who provides goods or services, a person on device 100's contact list, the entity operating layer 302, etc.), and/or a payment requestor (e.g., the entity operating layer 302 in this embodiment). In the case of a web-based purchase (e.g., through an on-line retailer), data may be retrieved from the web page, such as the product identifier, price, etc. In one embodiment, the password for the user's payment provider account is not sent from device 100 to layer 302, though in alternative embodiments the password may be sent. In another embodiment, layer 302 does not send the password for the user's payment provider account to layer 300, though in alternative embodiments the password may be sent. System 320 acts as an intermediary or proxy between device 100 and server 301, while optionally providing additional functionality as described herein. Server 320 may be configured to select a supplier identifier, such as from application catalog database 332, which may comprise the identifier of supplier's payment provider account. Server 320 may be configured to generate a transaction or payment message comprising the supplier identifier, transaction amount, and user identifier received from step 346 and to transmit the transaction message to server 301 for payment processing. As shown at step 348 in FIG. 3, system 320 is configured to use a secure connection and an application program interface to server 301 to send a transaction message to server 301. The transaction message may further comprise the security file received during step 344 so that the payment provider may confirm that the transaction request or requests are authorized. System 320 may further be configured to transmit transaction fee data to the payment provider representing the transaction fee to be paid to the operator of intermediate layer 302. The transaction fee may be transmitted in the same or a different message from the transaction message associated with the supplier ID. In one exemplary embodiment, a single message may be provided indicating that the developer is to be paid a certain fee for the purchased application and that the entity operating layer 302 is to receive a percentage of that fee or a smaller fee for providing intermediary services. The fee information may be retrieved from application catalog database 332 or other memory. Server 301 may be configured to handle the payment using payment handling unit 308 and fulfill the payment using payment fulfillment 310 by crediting or debiting certain accounts stored by the server and/or providing transaction data to other institutions, such as a bank, credit card issuer, etc., which may be transmitted by electronic or paper means, ACH debit, or other debiting or crediting mechanisms. An indication may be provided from server 301 to system 320 of the success or failure of the transaction. An indication of the success or failure may then be provided to the device which may be displayed to the user at a user interface on device 100.

According to one embodiment, the entity operating system 320 at the intermediate service layer is also the entity that is offering a product such as an application for purchase, as through applications store 326. In this use case, device 100 is configured to download and purchase the entity's application. In this case, system 320 is configured to identify the entity as the recipient of the payment to payment provider 300, such as by selecting the supplier ID from memory associated with the entity operating layer 302. The amount that is debited from the user/buyer's account on system 301 to pay for the application is funded or credited to the entity's account also stored on system 301.

In an alternative embodiment, developer 334 is a third party or marketplace provider. In this case, system 320 connects seller and buyer to the payment fulfillment service provided by the payment provider 300. In this case, the entity associated with system 320 registers with payment provider 300 to receive an account which system 301 stores. The third party provider's account identifier is also stored. During each payment fulfillment, the third party provider's account identifier is included in the transaction message. The account identifier allows the payment provider to recognize the entity as a marketplace provider and an appropriate revenue fee is calculated.

According to one embodiment, prior to each purchase, device 100 will prompt the user to enter a credential, such as a password, so that the user may be authenticated directly with payment provider 300, such as without sending a message through system 320 or without gaining authentication data through system 320. Advantageously, this prevents the sending of a password to another entity, which may reduce the risk of breach of the security credential. According to one embodiment, the user password may be used for authentication only with a payment provider and will not be used for other usages on device 100 or system 320, such as debug logging or otherwise persisting to a database.

According to one embodiment, when a purchase is requested by device 100 at step 346 (FIG. 3), the payment instruction or request will be sent to system 320. The payment instruction or request may comprise the user's security file (e.g., authentication token, etc.), the amount being charged, and an identification of the product being purchased. System 320 may be configured to look up the supplier identifier (e.g., a developer, partner, or other retailer or seller, etc.), which may be the account identifier of the supplier. System 320 may further be configured to look up a transaction fee or one or more transaction fees. System 320 may then create one or two or more transaction requests to be provided to the payment provider. A first transaction request may be a request for payment from an account associated with the user of device 100 to a developer account. A second payment request may comprise a transaction fee portion to be paid from the user or developer account to the account associated with the entity operating system 320, which may be a manufacturer of device 100. Records of any and all of the messages in or out of system 320, such as transaction records, requests sent, success or failure of the requests, payments fulfilled, etc., may all be stored in payment history database 330. Similarly, any payment histories may also be stored at layer 300 or layer 304. According to one embodiment, a record of a purchase may be stored at database 330 without any user information or information identifying the user or username to protect the privacy of the user, though the data may be used for statistical, heuristic, or reporting purposes.

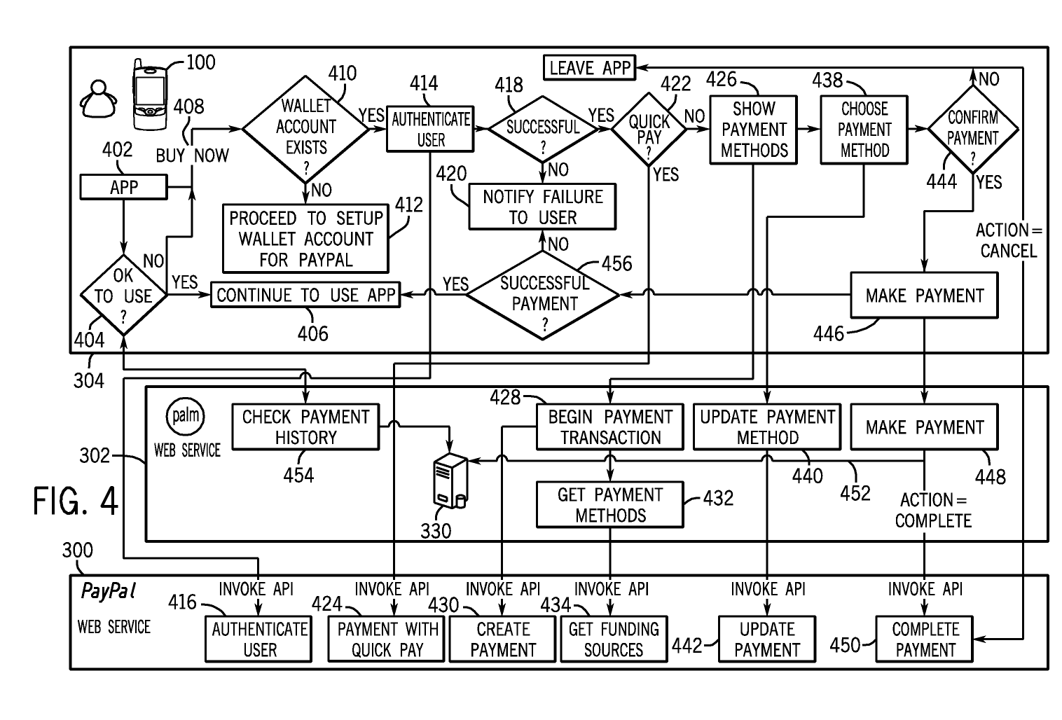

Referring now to FIG. 4, an exemplary algorithm for payment transaction processing for mobile computing devices will be described. The algorithm comprises elements operable on the computing elements of each of layers 300, 302 and 304. In this embodiment, the product to be used is an application 318 (FIG. 3) downloaded from application store 326 (FIG. 3) through an application discovery process (e.g., viewing a list of applications available for purchase from device 100, selecting one for download to device 100, downloading, etc.) At step 402, the application is selected for installation and/or operation on device 100. Some applications will allow an initial trial period without charge. At step 404, if the application may be used without payment, the user may continue to use the application (step 406). If the application may not be used further without payment, the user is prompted to pay or buy now (step 408) on a display of device 100.

At step 410, device 100 determines whether a payment account exists on device, such as may be set up using the system and method of FIG. 6. If no payment account has yet been created or verified on device 100, the process proceeds at step 412 to set up such an account as described in exemplary form with reference to FIG. 6. If a payment account exists, the process continues to step 414 where the user is authenticated. If the application or product being purchased may be purchased using one of a plurality of payment providers, the user is prompted to select one of the payment providers or methods so that the later request for a security file is sent to the proper payment provider. As described hereinabove, the developer of the application may select the available payment providers based on with which providers the developer has an account. If the user selects a payment provider with whom they have not yet verified/validated an account, the process will allow them to first verify/validate their account with that payment provider (which may also include creating an account with that provider through layer 302 or by directing the user directly to layer 300). At step 414, one or more user credentials is received from the user and sent (directly in this embodiment) to layer 300 via an API to a user authentication unit 416. User authentication unit 416 is configured to receive the one or more user credentials and make a determination (e.g. by comparing e-mail/password data, phone/PIN data, or other data to account data) as to whether the user credentials meet the authentication criteria. User authentication unit 416 is configured to return a message to device 100 indicating whether the request for user authentication was a success or failure, which may further return a security file, such as a session token which may be used by device 100 to initiate a payment process step. A session token should be used by the next call to system 301. The use of a latest session token will keep the user login session valid so that the user does not need to login once being authenticated. In one embodiment, the session token may be no longer valid after a predetermined period of time, such as after 10 minutes, or after a predetermined period of time of inactivity. At step 418, if user authentication was not successful, the user is notified at step 420. As a result, the user may be prompted for another try at authentication, access to the application may be blocked, etc.

If the user authentication was successful, at step 422, device 100 determines whether the user has configured the user account for a simplified payment process (e.g., a quick pay, easy pay, “pay now”, “one-click”, or other simplified payment process). The user may store an indication of whether a simplified payment process should be used as a preference in the user's payment provider account, device 100 payment account, or other in another location in memory. In a standard payment process, the user will be prompted to select a funding source and shipping address before making the payment. In a simplified payment process, device 100 may be configured to authorize system 320 to fulfill a payment on behalf of the user once a simplified purchase process and agreement are set up, so that device 100 need not prompt the user for an account password for each purchase. A simplified payment process may be any payment process that reduces one or more steps in the payment process (e.g., selecting a credit card or payment account (e.g., a bank checking account, savings account, etc.), entering or selecting a shipping or billing address, selecting financing, etc.)). In this embodiment, a “one-click” simplified payment process may be used, in which a “buy now” or single input results in purchase of the product without requiring further user input. If a simplified payment process is to be used for this transaction, device 100 sends a payment request through layer 302 to an API of layer 300 to a “payment with quickpay” unit 424. Unit 424 is configured to carry out (start and finish) the payment using default options, such as a default credit card, etc.

If a simplified payment process it not to be used, at step 426, payment options are displayed to the user, which may include one or more user accounts with one or more payment providers, shipping information, billing information, coupon information, etc. Portions of the payment methods may be retrieved from layer 300. At step 428, system 320 is configured to begin a payment transaction by sending a message to a create payment unit 430 which creates a payment to start a commercial transaction flow. Unit 301 returns a new session token and a flow context token. At step 432, a “get payment methods” request is sent through an API to a get funding sources unit 434 which returns primary and backup funding sources stored in the user's payment provider account. System 320 returns data indicative of these funding sources to device 100 for display to the user and to receive a selection thereof at step 438.

At step 438, a payment source is selected by the user and a message indicative thereof is sent to system 320 which updates the payment method at step 440 (which may further be stored as a default for future payment transactions). System 320 forwards the data indicative of a selected payment source through an API to an “update payment” unit 442 which is configured to updated the current payment with funding sources and shipping address as selected by the user. At step 444, the user is prompted to confirm payment. Purchase details may be displayed to the user to allow the user to edit or confirm any of the purchase details (e.g., payment source, shipping address, etc.). Upon receipt of a user input to confirm payment, a make payment step 446 commands a make payment step 448 at layer 302 to send a message through an API to “complete payment” unit. Server 301 stores a list of payments which are not complete. Upon receipt of a complete payment message from layer 302, the most recent payment selected is completed. Upon expiration of the session token, the associated payment is removed from the list and will not be allowed to complete. An indication of this may be provided to the user of device 100. The user may be prompted via device 100 to request a new security file, such as a session token.

Any of the steps described in FIG. 6 may be stored in payment history database 330 such as, for example, a payment completion request and any confirmation received from layer 300, as shown by line 452. A check payment history step 454 may further be provided which checks whether payment for an application has been received or is current and informs step 404 whether the application may be used. Similarly, step 456 operable on device 100 is configured to determine whether payment for the application has been completed or is current and confirms that the application may continue to be used at step 406.

The systems and methods described herein may be configured to process payments in a variety of forms, such as a one time charge, a multi-use charge, a recurring or periodic charge, etc. In a one-time charge, the systems may be configured to charge the user and process a payment for a fixed price either prior to download of the application or during a first use of the application and, thereafter, the user is authorized to continue using the application. An exemplary application might be a game application. In a subscription charging model, the systems may be configured to charge the user and process payments for a fixed amount on a recurring basis (e.g., monthly) with the ability to cancel after a minimum subscription period (if one is set) expires. An exemplary application might be a news aggregator application. In a pay-per-use charging model, the systems may be configured to charge a user and process payments as content or services are consumed, using a preferred payment method or taken out of a prepaid account balance. An exemplary application might be a pay-per-view media application. In a single-use license model, the systems may be configured to charge a user and process a payment of a fixed price to obtain a license to use an application for a fixed period of time. An exemplary application might be a point-to-point driving direction application, for example when traveling in a foreign city. In a multi-use license model, the systems may be configured to charge a user and process a payment for a single price for a set of N user licenses that allows use of the service by those users for a fixed period of time. Exemplary application might be those useful in a corporate setting, or among family, friends or a buddy list. In a try & buy model, the systems may be configured to allow the user free use of the application for an introductory period and then may prompt the user to pay to continue use. This model may be combined with any of the prior charging models. In a bundled purchase charging model, the systems may be configured to charge a user and process a payment for a set price (e.g., one-time or recurring) that permits them to use any one of a suite of applications and services.

According to one embodiment, developers 334 may implement their own payment processing software for their applications (or for some of their applications, wherein other applications may use the payment service provided by layer 302). Choosing the user of layer 302 allows collecting payment history from a payment provider (as described in greater detail herein) and verification of the amount paid by any particular device.

According to one embodiment, the entity operating layer 302 creates an account for itself with payment provider 300, developer 334 creates an account via a web site co-branded between the entity operating layer 302 and the payment provider (and operable on either or both entity's systems), and the user creates an account with the payment provider using the systems and methods described herein or has a pre-existing account.

A user's account with payment provider may have different payment preferences selected and either a current or out-of-date financial account (such as a credit card account, bank account, etc.), and the functioning of the system of FIG. 6 may changed depending these differences. One example is a simplified payment process default (e.g., a quick payment process) wherein the user's credit card is current. In this example, the payment provider uses the simplified payment process for the transaction, and the intermediate layer and device 100 need not prompt the user for funding sources or shipping method and may proceed with the simplified payment without additional user input (beyond invoking the product selection and payment). In another example, a simplified payment process is selected, but the financial account data is not current (e.g., the credit card has expired). In this example, the payment provider sends an e-mail notification to device 100 to update the credit card information. The intermediate layer may also send a message to the user to update credit card information. Once credit card information is updated, the simplified payment process can proceed. In another example, the simplified payment process is disabled, but the financial account information is current. In this example, the payment provider allows the user to choose a financial account when purchasing. The intermediate layer begins payment, retrieves payment methods, chooses credit card methods of payment, updates payment information and completes the payment. In another example, the simplified payment process is disabled and the credit card information is not current. The payment provider requires the user, upon receiving a request for purchase, to update the credit card and issues a single use token as the security file. The intermediate layer may ask the user to update the credit card information, start payment, retrieve payment methods, choose the credit card method of payment, update payment and complete the payment. In yet another example, the simplified payment process is disabled and the user does not have a credit card number on file in their account. In this example, the payment provider asks the user for a credit card number or other financial account information and issues a single use token as the security file. The intermediate layer asks the user for the financial account information, starts payment, retrieves payment methods, chooses the credit card method of payment, updates the payment and completes the payment. In each of these examples, the payment provider and intermediate layers may interact as described with reference to FIG. 6, or may operate differently, such as, for example where the payment provide may contact the user directly instead of via the intermediate layer. The payment provider system may have APIs that allow the intermediate layer to determine whether the account has a simplified payment process set up and/or to enable such a service on the user account, that allow the intermediate layer to add a credit card or update an expired credit card to the user account on the payment provider's system, that allow the intermediate layer to set up recurring payments, and that allow retrieval of payment history within a given date range.

### Payment History

Intermediate layer 302 may store payment history information in payment history database 330 at any of the steps described herein and in any of a variety of formats. Layer 302 may be configured to provide payment history reporting services to the users of device 100, developers 334, payment providers 300, and to itself for various statistical analyses, trending, heuristic analyses, etc. A payment history record may comprise the amount paid, payment method or account identifier, shipping address, status of payment, an identification of the goods being purchased, transaction date, etc. The identification of the goods being purchased may be retrieved from system 301 using a “recent history” API, directly from device 100, from its own database of applications 332 or from any other source. Payment history data may be collected by layer 302 during payment facilitation and/or may be received periodically by way of a payment transaction history “push” or “pull” of data from system 301. A payment handler service of system 320 may be configured to persist historical data and expose a payment verification API to allow applications to query the status of payment transactions for a specific device.

System 320 (FIG. 3) may be configured to generate payment reports from payment history database 330 for viewing by or sending to developer 334. For example, a report may be generated indicating how many times the developer's applications/services are purchased by devices 100, how much money is collected, how much transaction fees are charged/collected, etc., which may be reported for one or more predetermined periods (e.g. monthly, quarterly, etc). Payment provider system 301 may further be configured to generate transaction history reports, for example, an aggregated view of all transactions for developer's account for a predetermined period of time. The report from system 301 may comprise transaction data submitted to system 301 outside of or without the user of intermediate layer 302.

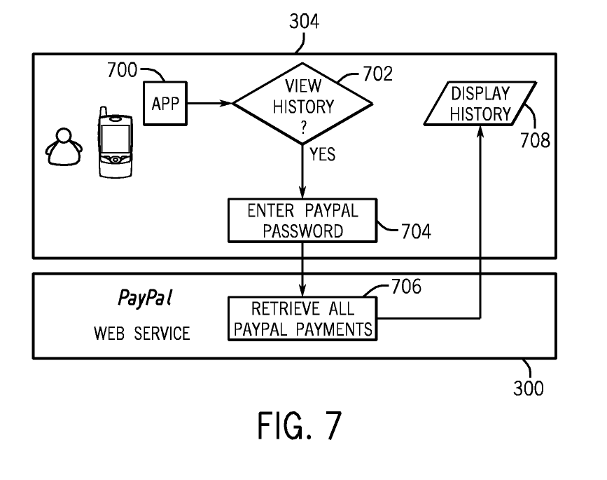

Referring now to FIG. 7, an exemplary flow diagram illustrating a payment history viewing process will be described. At step 700, the payment manager application 316 (FIG. 3) is operated or invoked by the user. At step 702, device 100 receives a user request to view or generate payment history records or reports, which may be based on criteria provided by the user for the report (e.g., reporting period, types of payments, etc.). At step 704, payment manager application 316 is configured to prompt the user for user credentials, such as credentials for a payment provider account. The credential or credentials are sent to system 301 either directly or via intermediate layer 302, for example via an API call. At step 706, system 301 is configured to retrieve the requested payment or transaction records, provide any formatting, and send the records to device 100, either directly or through layer 302 (as shown at step 350 in FIG. 3). At step 708, the historical data is displayed to the user on device 100.

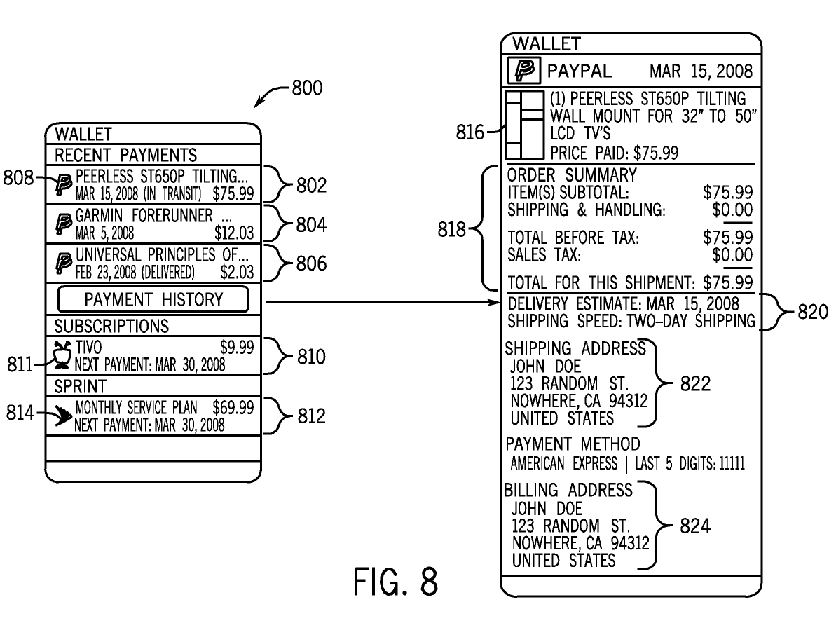

Referring to FIG. 8, a user interface and flow diagram illustrating a payment history viewing process will be described according to an exemplary embodiment. A user interface 800 is generated by the payment manager application 316 (FIG. 3) to present payment history data to a user. In response to a user request to view payment history information received at device 100, device 100 sends a request to system 320 to send payment history data, along with any parameters or criteria of the search request. System 320 retrieves payment history data from database 330 and/or from payment provider system 301 (e.g., step 350) and sends the data to device 100. Device 100 may be configured to present the data in any suitable format. In this example, a plurality of transactions 802, 804, and 806 are displayed along with product identification information, price, date of transaction, and the payment provider identifier 808. A second field for subscription payments 810 may be provided on the display along with the price of the subscription, service provider identifier 811, etc. A third field for wireless service accounts 812 may be provided on the display, along with the price, service provider identifier 814, etc.

Upon user selection of one of the payment entries in any one of the fields, additional data may be displayed and/or retrieved from layers 300 and/or 302 and displayed, such as an image of the product 816, a detail of costs 818, delivery status 820 and method, shipping address 822, billing address 824, and other data.

According to one exemplary embodiment, intermediate layer 302 may be configured to not store any financial information for the user, such as a credit card number, and/or device 100 may be configured to not store any financial information for the user, such as a credit card number.

According to one advantageous aspect, a software development kit (SDK) may be offered to developers of applications for purchase using the systems and methods described herein. The SDK may provide an interface to process payment requests from applications on the device to different payment providers. The SDK may be operable by device 100 and accessible by applications created by third party developers, who can configure applications to call the SDK by passing service requests in the proper format to the request channel on the mobile device 100. The SDK may be configured in response to a developer request to list the available payment providers for a given platform, list the number of payment provider end-user accounts verified for a given platform, process a payment transaction given a specific payment provider (with transaction details passed as arguments), and derive if the payment for a specific good/service was made by this end-user physically on a specific device 100.

In one embodiment, for a given transaction, authentication of the user occurs directly between device 100 and the payment provider system 301, while processing of the transaction is done by system 320 which proxies the payment request for system 301.

In one exemplary embodiment, system 320 will not persist the details of the transactions due to security and compliance reasons. In other embodiments, portions or all of the details of the transactions may be stored in memory, such as payment history database 330.

Exemplary payment provider APIs have been described herein, but other APIs may be used. For example, an API to retrieve account balances in the user's payment provider account may be used by layer 302, an API to obtain payment provider account information about the user and the user's current payment may be used by layer 302, etc.

According to one example, system 320 may be configured to rollback or refund a transaction to device 100 to refund the transaction fee or full purchase price of an application.

Referring to FIG. 3, at step 354, system 320 may be configured to verify whether an application has been purchased by device 100 or not, which is a service provided to the third party application to verify whether the device user has the right to use the application that requires purchase.

According to one alternative embodiment, tokens for each of the transaction requester (in this case the entity operating layer 302), the user of device 100, and the developer or other party to receive payment may be generated by system 301 and used in a transaction request message generated by system 320.

The embodiments disclosed herein have been described with reference to block diagrams and flow diagrams. Each block may represent one or more computer programs (e.g., software, firmware, etc.) and/or the hardware or processing circuitry on which the computer programs operate (e.g., microprocessors, microcontrollers, applications-specific integrated circuits, programmable logic, programmable gate array, etc.). Use of the term module, circuit or unit herein may refer to either computer program and/or circuit components operating the computer program to carry out the functions described herein. Modules may interface with other modules at a hardware and/or computer program level, and may operate at and/or interface with other modules at any applicable computer program level specified in the Open Systems Interconnection (OSI) model, such as application layer, presentation layer, session layer, transport layer, network layer, data link, physical layer, etc. Modules may be represented by a block, multiple blocks or portions of blocks in the various figures herein.

The systems and methods described herein may comprise units, modules, circuits or circuit portions, mechanisms, or devices, as part of a machine or apparatus, each of which performs one or more of the processes or functions described herein. Each such unit may comprise a computer program portion, code, software, or other computer-readable data operating on suitable electronic circuitry, which may be general-purpose or specific-purpose circuitry and may include one or more microprocessors, microcontrollers, application-specific integrated circuitry, programmable logic, or other analog and/or digital circuit elements. The code may be stored in or on a computer-readable medium, such as a memory (e.g., compact disk, digital versatile disk, computer memory, such as read-only memory, programmable read-only memory, flash memory, magnetic drive, hard drive, tape drive, firmware, or any other memory) which memory may be accessed by or configured to be read or operated by a processor to operate the code or be configured to transfer the code (e.g., via electronic transmission, wireless transmission, or physical transmission, such as via a retail store or in a package delivered through the mail) to another computer-readable medium (e.g., a memory) for operation by another processor (e.g., a processor associated with the memory or otherwise configured to read the memory). In any case, the computer program is configured to cause the processor operating the program to provide one or more of the functions, processes, or steps described herein. The organization of the units as set forth in herein is exemplary and in practice the functions may be organized in modules, objects or routines different than as set forth herein, or the units may share certain functions described herein. The code may be programmed in any of a variety of programming languages, such as FORTRAN, C, C++, C#, Java, etc., and may comprise machine code, source code, object code, or other types of code.

While the exemplary embodiments illustrated in the FIGS, and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A server computer system, comprising:
a memory configured to store supplier identifiers for a plurality of product suppliers; and
a processing circuit configured to receive a request to make a payment from a mobile computing device via a wireless communication, to select a supplier identifier from the memory based on the request, to generate a message comprising the supplier identifier, transaction amount, and a user identifier identifying a user of the mobile computing device, and to transmit the transaction message to a server associated with an entity which processes a transaction based on the transaction message.

2. The server computer system of claim 1, further comprising a database configured to store applications available for purchase from the plurality of product suppliers, wherein the processing circuit is further configured to provide a list of the applications to the mobile computing device and to receive a selection of at least one of the applications from the mobile computing device, wherein the request to make a payment relates to the selected application.

3. The server computer system of claim 1, further comprising a database configured to store transaction history data based on the transaction message and other transaction history data of transactions processed by the server for the mobile computing device.

4. The server computer system of claim 3, wherein at least a portion of the transaction history data or other transaction history data is received from the server associated with the entity.

5. The server computer system of claim 1, wherein the processing circuit is configured to store a record of the transmitted transaction message in a file that does not contain data identifying the user of the mobile computing device.

6. The server computer system of claim 1, wherein the request comprises an authentication token issued by the entity to the mobile computing device.

7. The server computer system of claim 1, wherein the processing circuit is further configured to transmit a transaction fee data to the entity for a transaction fee to be paid to the entity operating the server computer system.

8. The server computer system of claim 1, wherein the processing circuit is configured to generate a product supplier account based on product supplier.

9. A mobile computing device, comprising:
a wireless transceiver; and
a processing circuit, wherein the processing circuit is configured to receive a credential regarding a user of the mobile computing device, to transmit the credential via the wireless transceiver to an authenticating server, to receive a security file from the authenticating server, and to send a payment request comprising the security file to a second server via the wireless transceiver.

10. The mobile computing device of claim 9, wherein the security file comprises at least one of a token and a certificate.

11. The mobile computing device of claim 9, wherein the second server has a different internet protocol address than the authenticating server.

12. The mobile computing device of claim 9, wherein the processing circuit is configured to receive from the second server a list of applications and to receive from a user a selection of at least one of the applications, wherein the payment request is based on the selected application.

13. The mobile computing device of claim 9, wherein the credential comprises a password, wherein the processing circuit is configured to delete the password from memory at any point in time after transmitting the security file to the authenticating server.

14. The mobile computing device of claim 9, further comprising encrypting the credential for transmission to the authenticating server.

15. The mobile computing device of claim 9, wherein the mobile computing device is a handheld computer.

16. A mobile computing device, comprising:
a wireless transceiver;
a display;
a non-volatile memory configured to store a payment application, wherein the payment application comprises user interface elements stored in the non-volatile memory; and
a processing circuit configured to operate the payment application, to control the display to provide a user interface based on the user interface elements stored in the non-volatile memory, and to receive a user credential from the user and a user request to process a payment from the user, wherein the processing circuit is configured to generate a transaction request message based on the request to process a payment and to send the transaction request message via the wireless transceiver to a remote computer.

17. The mobile computing device of claim 16, wherein the processing circuit is configured to receive transaction history data from the remote computer and to display the transaction history data on the display.

18. The mobile computing device of claim 16, wherein the payment application is not an Internet browser application.

19. The mobile computing device of claim 16, wherein the processing circuit is configured to receive a list of applications available for purchase, to display data relating to the applications on the display, and to receive a user selection of an application for download.

20. The mobile computing device of claim 19, wherein the mobile computing device is a handheld computer.
